(19) United States
(12) Patent Application Publication
(10) Pub. No.: US 2010/0119429 A1
(43) Pub. Date: May 13, 2010

(54) METHODS OF MAKING METAL OXIDE NANOPARTICLES

(75) Inventors: Sarah M. Mullins, St. Paul, MN (US); Grant F. Tiefenbruck, Cottage Grove, MN (US); Danny B. Anderson, North St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/680,365

(22) Filed: Feb. 28, 2007

(51) Int. Cl. C01G 49/02; C01G 49/00; C01F 17/00; C01G 49/08

(52) U.S. Cl. 423/263; 423/632; 423/594.1; 423/594.2; 977/895; 977/773

(57) ABSTRACT

Methods of preparing metal oxide nanoparticles are described. The methods involve the thermal decomposition of a metal-carboxylate complex within a continuous, flow-through, tubular reactor. The resulting metal oxide nanoparticles contain iron and can be magnetic, non-agglomerated, crystalline or a combination thereof.

### TECHNICAL FIELD

Methods of preparing metal oxide nanoparticles are described.

### BACKGROUND

Various approaches have been suggested for the preparation of nanoparticles of metal oxides that contain iron. Some of these methods have involved the formation of an iron-containing complex and then thermal decomposition of the iron-containing complex. These methods have proven to be problematic, however, when large amounts such as 100 grams or greater of the nanoparticles are desired. More particularly, it has been difficult to prepare large quantities of iron-containing metal oxide nanoparticles, such as particles having an average size no greater than about 100 nanometers, with a relatively uniform particle size distribution.

### SUMMARY

Methods of preparing iron-containing metal oxide nanoparticles are described. The methods involve the thermal decomposition of an iron-carboxylate complex within a continuous, flow-through, tubular reactor. The resulting metal oxide nanoparticles can be magnetic, non-agglomerated, crystalline, or a combination thereof.

A first method of preparing iron-containing metal oxide nanoparticles is provided that includes preparing a feed composition that contains (a) a precursor that includes an iron-carboxylate complex, (b) a surfactant that includes a first carboxylic acid, a salt of the first carboxylic acid, or a mixture thereof, and (c) a first organic solvent. The method further includes passing the feed composition through a continuous, tubular reactor to form a reactor effluent that includes the iron-containing metal oxide nanoparticles. The tubular reactor is held at a reactor temperature that is greater than a decomposition temperature of the iron-carboxylate complex.

A second method of preparing iron-containing metal oxide nanoparticles is provided that includes preparing a feed composition that contains (a) a precursor that includes an iron-carboxylate complex, (b) a surfactant that includes a first carboxylic acid, a salt of the first carboxylic acid, or a mixture thereof, and (c) a first organic solvent. The method further includes passing the feed composition through a continuous, tubular reactor to form a reactor effluent containing the iron-containing metal oxide nanoparticles. The tubular reactor is held at a reactor temperature that is greater than a decomposition temperature of the iron-carboxylate complex. In this method, the iron-carboxylate complex in the feed composition is formed by a process that includes preparing an iron-containing salt solution that contains (i) an iron-containing salt and (ii) an aqueous-based solvent. The process of forming the iron-carboxylate complex further includes mixing a complexing agent with the iron-containing salt solution. The complexing agent contains a second carboxylic acid, a salt of the second carboxylic acid, or a mixture thereof. The iron-carboxylate complex is extracted into a nonpolar organic solvent.

A third method of preparing iron-containing metal oxide nanoparticles is provided that includes preparing a feed composition that contains (a) a precursor that includes an iron-carboxylate complex, (b) a surfactant that includes a first carboxylic acid, a salt of the first carboxylic acid, or a mixture thereof, (c) a first organic solvent, and (d) iron-containing metal oxide seed particles. The method further includes passing the feed composition through a continuous, tubular reactor to form a reactor effluent containing the iron-containing metal oxide nanoparticles. The tubular reactor is held at a reactor temperature that is greater than a decomposition temperature of the iron-carboxylate complex. The resulting iron-containing metal oxide nanoparticles have an average particle size that is greater than an average particle size of the iron-containing metal oxide seed particles.

### BRIEF DESCRIPTION OF THE DRAWINGS

The invention may be more completely understood in consideration of the following detailed description of various embodiments of the invention in connection with the accompanying drawings, in which:

FIG. 1 is a schematic representation of an exemplary tubular reactor system.

FIG. 2 is a transmission electron micrograph of a magnetite that was not prepared in a continuous, tubular reactor. The magnification is 50,000×.

FIG. 3 is a transmission electron micrograph of a first exemplary magnetite prepared in a continuous, tubular reactor. The magnification is 300,000×.

FIG. 4 is a transmission electron micrograph of a second exemplary magnetite prepared in a continuous, tubular reactor. The magnification is 100,000×.

FIG. 5 is a transmission electron micrograph of a third exemplary magnetite prepared in a continuous, tubular reactor. The magnification is 100,000×.

FIG. 6 is a transmission electron micrograph of a fourth exemplary magnetite prepared in a continuous, tubular reactor. The magnification is 100,000×.

### DETAILED DESCRIPTION

Methods of preparing nanoparticles of iron-containing metal oxides are provided. As used herein, the term “nanoparticles” refers to particles having an average size in the range of 1 to 100 nanometers. The terms “iron-containing metal oxide nanoparticles” and “metal oxide nanoparticles” are used interchangeably herein and typically refer to a compound of formula Fe₂O₃, M¹Fe₂O₄, M²FeO₃, M¹M²FeOₓ, or a mixture thereof where M¹ is selected from iron, cobalt, nickel, copper, zinc, chromium, manganese, titanium, vanadium, barium, magnesium, calcium, strontium, or mixtures thereof; M² is a rare earth; and x is a number no greater than 4. As used herein, the term “rare earth” refers to an element selected from a lanthanide, yttrium, scandium, or a mixture thereof. In some embodiments, the iron-containing metal oxide is magnetite (Fe₃O₄).

The methods involve the conversion of a precursor that contains an iron-carboxylate complex to iron-containing metal oxide nanoparticles within a continuous, flow-through, tubular reactor. As used herein, the terms “tubular reactor”, “continuous, tubular reactor”, and “continuous, flow-through, tubular reactor” are used interchangeably. Any desired amount of the iron-containing metal oxide nanoparticles can be prepared. For example, quantities in excess of 100 grams, 200 grams, 500 grams, or 1000 grams can be prepared.

The methods of preparing iron-containing metal oxide nanoparticles include preparing a feed composition that contains (a) a precursor that includes an iron-carboxylate complex, (b) a surfactant that includes a first carboxylic acid, a salt of the first carboxylic acid, or a mixture thereof, and (c) a first organic solvent. The method further includes passing the feed composition through a continuous, tubular reactor to form a reactor effluent containing the iron-containing metal oxide nanoparticles. The tubular reactor is held at a reactor temperature that is greater than the decomposition temperature of the iron-carboxylate complex.

As used herein the term “decomposition temperature” with reference to a metal-carboxylate complex such as an iron-carboxylate complex means the minimum temperature needed to convert the metal-carboxylate complex to a metal oxide, wherein the metal oxide that can be detected using x-ray diffraction. The decomposition temperature is often at least 200° C., at least 225° C., at least 250° C., or at least 275° C.

The various temperatures described herein refer to temperatures under atmospheric conditions.

The precursor in the feed composition contains an iron-carboxylate complex. The carboxylate species in the iron-carboxylate complex typically contains 6 to 30 carbon atoms. The carboxylate species often contains at least 8 carbon atoms, at least 10 carbon atoms, at least 12 carbon atoms, at least 14 carbon atoms, at least 16 carbon atoms, or at least 18 carbon atoms. The carboxylate species can be an aliphatic or aromatic group. In many examples, the carboxylate is an aliphatic group that contains an alkyl or alkenyl group and a carboxy group (—COO⁻). Examples of carboxylate species include, but are not limited to, oleate, stearate, octanoate, iso-octanoate, myristate, caproate, heptanoate, laurate, valerate, versalate, neodecanoate, benzoate, and mixtures thereof.

Some iron-carboxylate complexes are commercially available. For example, the following iron-carboxylate complexes are available from Pfaltz & Bauer (Waterbury, Conn.): iron(III)-octanoate (in mineral spirits), iron(III)-stearate, and iron(II)-stearate. Iron-octanoate is also commercially available from Shepherd Chemicals (Norwood, Ohio).

Iron-carboxylate complexes, such as those that are not commercially available, can be prepared by a process that includes preparing a salt solution that contains (i) an iron-containing salt and (ii) an aqueous-based solvent. The process of forming the iron-carboxylate complex further includes mixing a carboxylate-containing complexing agent with the iron-containing salt solution. The resulting iron-carboxylate complex is extracted into a nonpolar organic solvent.

More particularly, an iron-containing salt is usually dissolved in an aqueous-based solvent to form an iron-containing salt solution. The complexing agent is usually added to the iron-containing salt solution. The complexing agent includes a second carboxylic acid, a salt of a second carboxylic acid, or a mixture thereof. A nonpolar organic solvent that is not miscible with the aqueous-based solvent is added and the resulting mixture is often held at a temperature below the boiling points of the aqueous-based solvent and the nonpolar organic solvent for several hours. Heating tends to facilitate the formation of the iron-carboxylate complex and the extraction of the iron-carboxylate complex into the nonpolar organic solvent. The organic phase, which contains the iron-carboxylate complex and the nonpolar organic solvent, is then separated from the aqueous phase.

Although any order of addition of the iron-containing salt and the complexing agent to the aqueous-based solvent can used, it is often preferable to form an iron-containing salt solution before addition of the complexing agent. That is, the iron-containing salt is often dissolved in the aqueous-based solvent before the resulting solution is mixed with the complexing agent. The complexing agent can be added as a granulated material to this solution or can be dissolved in a solvent such as the aqueous-based solvent or the nonpolar organic solvent.

Any iron-containing salt that can be dissolved in the aqueous-based solvent can be used to prepare the iron-carboxylate complex and can include iron(II), iron(III), or a mixture thereof. Some exemplary iron-containing salts have an anion selected from a halide (e.g., bromide or chloride), nitrate, sulfate, phosphate, or acetate. More specific iron salts include, but are not limited to, iron(III) chloride, iron(II) chloride, iron(III) sulfate, iron(II) sulfate, iron(II) acetate, and iron(III) nitrate. A mixture of these iron-containing metal salts can be used. The iron-containing salts can be hydrated, partially hydrated, or anhydrous.

The aqueous-based solvent used to prepare the iron-carboxylate complex can be entirely water or can contain a polar organic solvent that is miscible with water. The polar organic solvent is often added to increase the solubility of the complexing agent in the aqueous-based solvent. Suitable polar organic solvents include, for example, alcohols, dimethylsulfoxide, dimethylformamide, N-methylpyrrolidone, acetonitrile, acetone, tetrahydrofuran, and the like. In some embodiments, the polar organic solvent is an alcohol having no greater than 6 carbon atoms, no greater than 5 carbon atoms, no greater than 4 carbon atoms, no greater than 3 carbon atoms, or no greater than 2 carbon atoms. Any volume ratio of water to polar organic solvent can be used. In some embodiments, the volume ratio of water to polar organic solvent is in the range of 1:10 to 1:0.1. For example, the volume ratio of water to polar organic solvent can be in the range of 1:5 to 1:0.5 or 1:2 to 1:0.2.

Any concentration of the iron-containing salt that is soluble in the aqueous-based solvent can be used. The concentration of iron in the aqueous-based solvent is often in the range of 0.05 to 1 moles/liter. For example, the concentration of iron can be in the range of 0.1 to 1 moles/liter, in the range of 0.1 to 0.8 moles/liter, or in the range of 0.1 to 0.5 moles/liter.

A second carboxylic acid, a salt of the second carboxylic acid, or a mixture thereof is added to the iron-containing salt solution as the complexing agent. Suitable cations for the salt of a carboxylic acid include, for example, ammonium ions, sodium ions, potassium ion, or lithium ions. The complexing agent often contains 6 to 30 carbon atoms. For example, the complexing agent can contain at least 8 carbon atoms, at least 10 carbon atoms, at least 12 carbon atoms, at least 14 carbon atoms, at least 16 carbon atoms, or at least 18 carbon atoms. Although the complexing agent can be either an aliphatic or aromatic compound, the complexing agent often has a carboxy group connected to a nonpolar group such as an alkyl or alkenyl. Exemplary complexing agents include, but are not limited to, stearic acid or salts thereof, oleic acid or salts thereof, or mixtures thereof. In some embodiments, the complexing agent is oleic acid, a salt of oleic acid, or a mixture thereof.

The molar ratio of the complexing agent to iron is typically chosen to be equal to the valency of the iron ions. For example, if the iron-containing salt includes iron(III), the molar ratio of the complexing agent to iron is three (i.e., 3 moles of complexing agent to 1 mole of iron(III)).

The iron-carboxylate complex is extracted into the nonpolar organic solvent. The nonpolar solvent is typically not miscible with the aqueous-based solvent. The nonpolar organic solvent is usually selected such that the solubility of the iron-carboxylate complex is greater in this solvent than in the aqueous-based solvent. Suitable nonpolar organic solvents are often aliphatic or aromatic hydrocarbons. Exemplary nonpolar organic solvents include, but are not limited to, alkanes (e.g., alkanes having 4 to 24 carbon atoms such as hexane, cyclohexane, heptane, octane, decane, hexadecane, and dodecane), alkenes (e.g., alkenes having 4 to 24 carbon atoms such eicosene and octadecene), and aromatics (e.g., aromatics having 6 to 10 carbon atoms such as benzene, toluene, xylene, and mesitylene). In many embodiments, alkanes such as hexanes or heptanes are used because these nonpolar solvents can be easily removed from the organic phase after extraction of the iron-carboxylate complex.

The volume of the nonpolar organic solvent is typically chosen to extract most, if not all, of the iron-carboxylate complex. The volume ratio of aqueous-based solvent to the first nonpolar organic solvent is typically in the range of 1:10 (i.e., 1 milliliter aqueous-based solvent for every 10 milliliters of nonpolar organic solvent) to 10:1 (i.e., 10 milliliters aqueous-based solvent for every 1 milliliter of nonpolar solvent), in the range of 2:10 to 10:2, in the range of 5:10 to 10:5, in the range of 8:10 to 10:8, or in the range of 9:10 to 10:9. In some examples, the volume ratio of the aqueous-based solvent to nonpolar organic solvent is in the range of 5:10 to 10:5 and the aqueous-based solvent contains at least 30 volume percent polar organic solvent, at least 40 volume percent polar organic solvent, at least 50 volume percent polar organic solvent, or at least 60 volume percent polar organic solvent.

Although the metal-carboxylate complex can be formed at room temperature in some embodiments, the reaction mixture is often heated at a temperature below the boiling points of the aqueous-based solvent and the nonpolar organic solvent. For example, the reaction mixture can be heated at a temperature up to 90° C., up to 80° C., up to 70° C., up to 60° C., or up to 50° C. for a period of time equal to at least 30 minutes, at least 1 hour, at least 2 hours, at least 4 hours, or at least 6 hours. The reaction mixture can be heated at a temperature in the range of 30° C. to 80° C., in the range of 30° C. to 60° C., or in the range of 40° C. to 60° C. for a period of time in the range of 1 hour to 8 hours, in the range of 2 to 8 hours, or in the range of 2 to 6 hours.

The aqueous phase is then separated from the organic phase, which contains most of the metal-carboxylate complex and the nonpolar organic solvent. The organic phase can be optionally washed with an aqueous phase to remove, for example, any impurities in the organic phase. The organic phase optionally can be concentrated to remove at least a portion of the nonpolar solvent. In many embodiments, most of the nonpolar organic solvent is removed and the concentrated organic phase predominately contains the iron-carboxylate complex. If substantially all of the nonpolar organic solvent is removed, the remaining iron-carboxylate complex concentrate can be a powder, oil, or wax. The physical state of the complex depends to a large extent on the particular complexing agent used. For example, an iron-oleate complex is usually an oil while an iron-stearate complex is usually a powder.

The reaction time, reaction temperature, and nonpolar solvent can be adjusted to provide at least 80 percent yield of the metal-carboxylate complex. In many embodiments, the percent yield is at least 85 percent, at least 90 percent, at least 92 percent, or at least 95 percent.

The nonpolar organic solvent included in the process of making the iron-carboxylate complex may or may not be suitable for use in the continuous, tubular reactor. Any of the nonpolar organic solvent that is not removed can function as all or a portion of the solvent (i.e., first organic solvent) included in the feed composition for the tubular reactor.

If the boiling temperature of the nonpolar organic solvent is less than about 100° C., some or substantially all of the nonpolar organic solvent is typically removed prior to preparing the feed composition for the tubular reactor. The presence of such a solvent may cause the pressure to be unacceptably high in the tubular reactor. Even if the boiling temperature of the nonpolar organic solvent is equal to or greater than 100° C., it may be desirable to remove all or a portion of this solvent prior to preparation of the feed composition for the tubular reactor. For example, in some embodiments, it may be desirable to remove the nonpolar organic solvent if the boiling point of this solvent is lower than the decomposition temperature of the iron-carboxylate complex.

For embodiments that remove some or substantially all of the nonpolar organic solvent prior to preparation of the feed composition for the tubular reactor, the nonpolar organic solvent is often selected to have a boiling temperature less than about 200° C., less than 150° C., less than 120° C., less than 100° C., or less than 80° C. Any suitable process can be used to remove some or substantially all of the nonpolar organic solvent. For example, the nonpolar organic solvent can be removed by evaporation or distillation. These processes are often conducted under vacuum conditions so that lower temperatures can be used to remove the nonpolar organic solvent.

In some specific embodiments of the method of making the iron-carboxylate complex, the nonpolar organic solvent is an alkane, alkene, or a mixture thereof. The alkane or alkene can have up to 10 carbon atoms, up to 8 carbon atoms, or up to 6 carbon atoms. For example, the nonpolar solvent can include a hexane, heptane, or a mixture thereof. In these embodiments, substantially all of the nonpolar organic solvent is removed prior to preparation of the feed composition for the tubular reactor. As used herein with reference to the removal of the nonpolar organic solvent, the term “substantially all” means that at least 90 weight percent, at least 95 weight percent, at least 97 weight percent, at least 98 weight percent, or at least 99 weight percent of the nonpolar organic solvent is removed from the organic phase.

In addition to the iron-carboxylate complex, the precursor for the continuous, tubular reactor can optionally contain an additional metal-carboxylate complex where the metal species is selected from a transition metal other than iron, rare earth element, alkaline earth element, or a mixture thereof. For example, the additional metal-carboxylate can include a metal species selected from cobalt, nickel, copper, zinc, chromium, manganese, titanium, vanadium, barium, magnesium, calcium, strontium, or a rare earth element.

Some of these additional metal-carboxylate complexes are commercially available. For example, the following metal-carboxylate complexes are available from Pfaltz & Bauer (Waterbury, Conn.): cobaltous-laurate, cobaltous-benzoate, cobalt-stearate, nickel-stearate, nickel-benzoate, copper-stearate, zinc-heptanoate, zinc-myristate, zinc-caproate, zinc-laurate, zinc-benzoate, zinc-valerate, zinc-stearate, chromium-oleate, chromium-stearate, manganese-oleate, manganese-octanoate (in mineral spirits), manganese-stearate, manganese-benzoate, barium-oleate, barium-stearate, barium-laurate, magnesium-stearate, and magnesium-benzoate. Other metal-carboxylate complexes are available from Shepherd Chemicals (Norwood, Ohio): chromium-isoctanoate, chromium-octanoate, cobalt-neodecanoate, cobalt-octanoate, cobalt-stearate, manganese-stearate, manganese-versalate, nickel-octanoate, strontium-octanoate, zinc-caprylate, zinc-oleate, and zinc-neodecanoate.

The additional metal-carboxylate complex also can be prepared using a method similar to that described above for preparing the iron-carboxylate complex. More specifically, other metal salts (i.e., salts that contain a transition metal other than iron, an alkaline earth element, or rare earth element) can be used in place of the iron-containing metal salt. Any metal salt that is soluble in the aqueous-based solvent can be used. The anions of these optional metal salts are often selected from a halide, nitrate, sulfate, phosphate, or acetate. More specific optional metal salts include, but are not limited to, cobalt(II) chloride, cobalt(III) chloride, cobalt(III) nitrate, cobalt(III) acetate, cobalt(III) sulfate, nickel(II) nitrate, nickel(II) chloride, nickel(II) sulfate, nickel(acetate), copper(II) chloride, copper(II) nitrate, zinc acetate, zinc chloride, zinc nitrate, chromium(III) chloride, manganese(II) chloride, barium chloride, strontium chloride, cerium(III) acetate, cerium(III) chloride, cerium(III) nitrate, and cerium(III) sulfate. These optional metal salts can be hydrated, partially hydrated, or anhydrous.

Returning to a description of the feed composition for the tubular reactor, the concentration of the precursor (i.e., iron-carboxylate complex plus any additional metal-carboxylate complex) in the feed composition for the tubular reactor can be any amount that results in the formation of metal oxide nanoparticles that are predominately non-aggregated. The terms “aggregated” and “aggregate” refer to clusters or clumps of nanoparticles that are firmly associated with one another and that can be separated only with high shear. Similarly, the term “non-aggregated” refers to nanoparticles that are substantially free of aggregates. Particle aggregation often can be detected using a technique such as transmission electron microscopy.

The precursor concentration is typically expressed in term of the metal species in the complex (e.g., in terms of the iron species in the iron-carboxylate precursor plus any metal species in an additional metal-carboxylate complex). The concentration of the metal species in the feed composition is often in the range of 10 to 500 millimolar. If smaller amounts of the metal species are used, the reactor effluent may contain an undesirably low concentration of metal oxide nanoparticles. If greater amounts of the metal species are used, however, the reactor effluent may contain an undesirable amount of aggregated metal oxide nanoparticles. In some embodiments, the concentration of the metal species is at least 10 millimolar, at least 20 millimolar, or at least 50 millimolar. The concentration of the metal species is often no greater than 500 millimolar, no greater than 400 millimolar, no greater than 300 millimolar, no greater than 200 millimolar, no greater than 150 millimolar, or no greater than 100 millimolar.

The precursor often includes only an iron-carboxylate complex. In embodiments where other additional metal-carboxylate complexes are present, at least 10 mole percent of the precursor is usually an iron-carboxylate complex. For example, at least 20 mole percent, at least 30 mole percent, at least 40 mole percent, at least 50 mole percent, at least 60 mole percent, at least 70 mole percent, at least 80 mole percent, or at least 90 mole percent of the precursor is the iron-carboxylate complex.

The surfactant included in the feed composition for the tubular reactor contains a first carboxylic acid, a salt of the first carboxylic acid, or a mixture thereof. The surfactant functions to prevent or minimize the aggregation of the metal oxide nanoparticles that form in the tubular reactor. The carboxylic acid or salt thereof that is used as the surfactant often contains 8 to 30 carbon atoms. The surfactant often has at least 10 carbon atoms, at least 12 carbon atoms, at least 14 carbon atoms, at least 16 carbon atoms, or at least 18 carbon atoms. In many embodiments, the carboxylate is an aliphatic compound that has a carboxy group attached to an alkyl or alkenyl group. Examples of complexing agents include, but are not limited to, oleic acid, stearic acid, myristic acid, lauric acid, salts of any of these carboxylic acids, or mixtures thereof. In some embodiments, the complexing agent is oleic acid, a salt of oleic acid, or a mixture thereof. Suitable cations for the salt of a carboxylic acid include, for example, ammonium ions, sodium ions, potassium ion, or lithium ions. The cations for the salt of a carboxylic acid are not metal species such as ions of transition metals, rare earth elements, or alkaline earth elements.

The surfactant can be the same as or different than the carboxylate species included in the precursor. That is, the surfactant can be the same or different than the complexing agent used to prepare the iron-carboxylate complex or any additional metal-carboxylate complex. In many embodiments, the same carboxylic acid, salt of the carboxylic acid, or mixture thereof is used as the surfactant and as the complexing agent. In some examples, the surfactant and the complexing agent are oleic acid or a salt thereof, stearic acid or a salt thereof, or a mixture thereof.

In addition to varying the concentration of the precursor, the extent of aggregation of the metal oxide nanoparticles can be controlled by varying the concentration of the surfactant in the feed composition for the continuous, tubular reactor. A greater amount of the surfactant typically favors less aggregation of the metal oxide nanoparticles. However, excess amounts of the surfactant can adversely affect the decomposition of the precursor to metal oxide nanoparticles. Additionally, excess amounts of the surfactant may need to be removed from the reactor effluent to provide metal oxide nanoparticles having an acceptable purity level.

The molar ratio of the precursor (i.e., iron-carboxylate complex plus any additional metal-carboxylate complex) to the surfactant is typically in the range of 1:10 to 10:1, in the range of 1:5 to 5:1, in the range of 1:3 to 3:1, or in the range of 1:2 to 2:1. In some example feed compositions, the molar ratio of the precursor to the surfactant is about 1:1.

Both the precursor and the surfactant are dissolved in a first organic solvent. The first organic solvent is desirably a liquid at room temperature and has a viscosity suitable for pumping through a tubular reactor. The first organic solvent is selected, in part, based on its ability to dissolve the metal-carboxylate complex. The first organic solvent preferably does not undergo decomposition reactions itself at the temperatures used to convert the precursor to iron-containing metal oxide nanoparticles. If the first organic solvent decomposes, the pressure in the tubular reactor may be unacceptably high.

In some embodiments, the first organic solvent is selected to have a boiling temperature that is greater than the decomposition temperature of the precursor. If the precursor contains only the iron-carboxylate precursor, the first organic solvent is usually selected to have a boiling temperature that is greater than the decomposition temperature of the iron-carboxylate complex. If the precursor contains an additional metal-carboxylate complex, the first organic solvent is usually selected to have a boiling temperature that is greater than both the decomposition temperature of the iron-carboxylate complex and the additional metal-carboxylate complex.

The first organic solvent is often an aliphatic compound having at least 14 carbon atoms or at least 16 carbon atoms. A mixture of first organic solvents can be used. Suitable first organic solvents often have 14 to 30 carbon atoms, 16 to 30 carbon atoms, or 16 to 24 carbon atoms. Some exemplary first organic solvents are alkanes such as linear alkanes having at least 16 carbon atoms. Specific alkanes that are suitable include, but are not limited to, hexadecane with a boiling temperature of 287° C. or octadecane with a boiling temperature of 317° C. Other exemplary first organic solvents are linear alkenes having at least 16 carbon atoms such as 1-hexadecene with a boiling temperature of 274° C., 1-octadecene with a boiling temperature of 317° C., or 1-eicosene with a boiling temperature of 330° C. Still other exemplary first organic solvents are trialkylamines having linear alkyl groups with at least 6 carbon atoms such as trihexylamine with a boiling temperature of 264° C. and trioctylamine with a boiling temperature of 365° C. Yet other exemplary first organic solvents are alkyl ethers having linear alkyl groups with at least 8 carbon atoms such as octyl ether with a boiling temperature of 287° C.

In some embodiments, the feed composition further includes seed particles. That is, the feed composition can contain a precursor, surfactant, seed particles, and a first organic solvent. For example, to prepare nanoparticles having a larger average particle size, the iron-containing metal oxide particles prepared in a first tubular reactor can be added as seed particles to a feed composition for a second tubular reactor.

The feed composition for the continuous, tubular reactor often has percent solids in the range of 1 to 25 weight percent. The percent solids are calculated by dividing the solids weight by the total weight of the solution and then multiplying by 100. The solids weight is typically equal to the weight of the precursor (i.e., iron-carboxylate complex and any additional metal-carboxylate complex) plus the weight of the surfactant. The total weight of the solution is usually equal to the weight of the precursor plus the weight of the surfactant plus the weight of the first organic solvent. If the solids are too low, the resulting metal oxide particles tend to be poorly defined and amorphous. If the solids are too high, however, the feed composition may be difficult to pump and there can be particulate buildup on the walls of the tubular reactor. Particulate buildup can be minimized, however, by using tubular reactors having a larger diameter or by using longer tubular reactors at a higher flow rate. Additionally, if the solids are too high, there is an increased likelihood that aggregated metal oxide particles will form in the tubular reactor. That is, dilute solutions tend to favor the formation of non-aggregated nanoparticles. In some exemplary feed compositions, the percent solids can be in the range of 5 to 25 weight percent, 5 to 20 weight percent, or 10 to 20 weight percent.

Feed compositions can be filtered prior to introduction into the tubular reactor, if desired. This may be advantageous if there is any insoluble material that is relatively large present in the feed composition. Insoluble material, at least in some embodiments, can adversely affect the particle size distribution of the resulting metal oxide nanoparticles. The insoluble material can be removed by filtration or centrifugation of the feed composition. In some embodiments, the feed composition can be passed through a filter having a pore size less than 5 microns, less than 3 microns, less than 2 microns, or less than 1 micron. The pore size is generally chosen so that any seed particles included in the feed composition are not removed by filtration. Suitable filters include, but are not limited to, those commercially available from Micron Separations, Inc. (Westborough, Mass.) under the trade designation “MAGNA NYLON” having a pore size of 0.45 microns or 1.2 microns. The feed composition can be passed through the filter by applying pressure to a surface of the feed composition. Alternatively, the feed composition can be passed through the filter by drawing a vacuum on the receiving vessel for the filtered feed composition.

After preparing the feed composition, the feed composition is passed through a continuous, tubular reactor to form a reactor effluent that contains the metal oxide nanoparticles. The tubular reactor is held at a reactor temperature that is greater than the decomposition temperature of the precursor. The resulting metal oxide nanoparticles contain iron. In many embodiments, the iron-containing metal oxide nanoparticles are Fe₂O₃, M¹Fe₂O₄, M²FeO₃, M¹M²FeOₓ, or a mixture thereof, where M¹ is selected from iron, cobalt, nickel, copper, zinc, chromium, manganese, titanium, vanadium, barium, magnesium, calcium, strontium, or mixtures thereof; M² is a rare earth element; and x is a number no greater than 4. In some embodiments, the metal oxide nanoparticles include magnetite (Fe₃O₄).

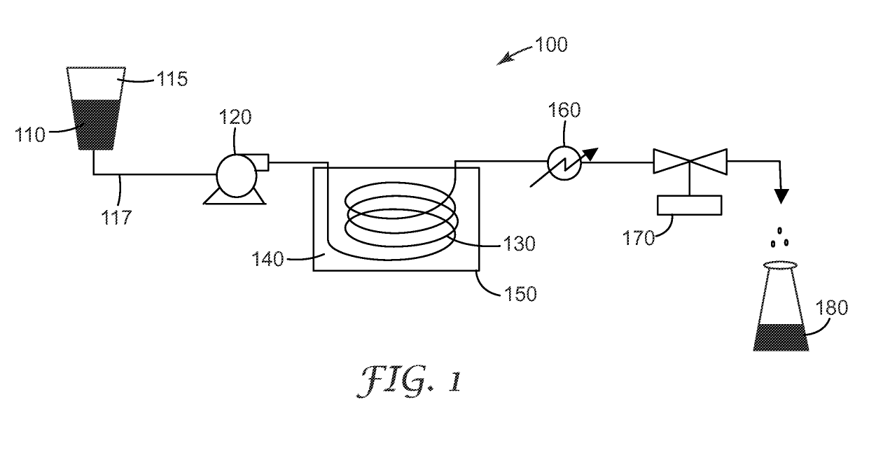

An exemplary continuous, flow-through, tubular reactor system 100 is shown schematically in FIG. 1. The feed composition 110 is contained within a feed composition tank 115. The feed composition tank is connected with tubing or piping 117 to a pump 120. Similar tubing or piping can be used to connect other components of the tubular reactor system. The pump 120 is used to introduce the feed composition 110 into the tubular reactor 130. That is, the pump 120 is connected to the inlet of the tubular reactor 130. Although the tubular reactor 130 is shown in FIG. 1 as a coil of tubing, the tubular reactor can be in any suitable shape. The shape of the tubular reactor is often selected based on the desired length of the tubular reactor and the method used to heat the tubular reactor. For example, the tubular reactor can be straight, U-shaped, or coiled.

As shown in FIG. 1, the tubular reactor 130 is placed in a heating medium 140 within a heating medium vessel 150. The heating medium 140 can be, for example, an oil, sand, salt, or the like that can be heated to a temperature above the decomposition temperature of the iron-carboxylate complex. Suitable oils include, for example, plant oils such as peanut oil and canola oil. Some plant oils are preferably kept under nitrogen when heated to prevent or minimize oxidation of the oils. Other suitable oils include polydimethylsiloxanes such as those commercially available from Duratherm Extended Fluids (Lewiston, N.Y.) under the trade designation “DURATHERM S”. Suitable salts include, for example, sodium nitrate, sodium nitrite, potassium nitrate, or mixtures thereof. The heating medium vessel 150 can be any suitable container that can hold the heating medium and withstand the heating temperatures used for the tubular reactor 130. The heating medium vessel 150 can be heated using any suitable means. In many embodiments, the heating medium vessel 150 is positioned inside an electrically heated coil.

The tubular reactor 130 can be made of any material capable of withstanding the temperatures used and the pressures generated during the decomposition reaction. In some embodiments, the tubular reactor is made of stainless steel, nickel, titanium, carbon-based steel, or the like. The second end of the tubular reactor 130 is usually connected to a cooling device 160. Any suitable cooling device can be used. In some embodiments, the cooling device is a heat exchanger that includes a section of tubing or piping with an outer jacket filled with a cooling medium such as cool water. In other embodiments, the cooling device includes a coiled section of tubing or piping that is placed in a vessel that contains cooling water. In either of these embodiments, the reactor effluent is passed through the section of tubing and is cooled from the reactor temperature to a temperature no greater than 100° C., no greater than 80° C., no greater than 60° C., or no greater than 40° C. Other cooling devices that contain dry ice or refrigeration coils can also be used. After cooling, the reactor effluent can be discharged into a product collection vessel 180. The reactor effluent is preferably not cooled below the freezing point of the first organic solvent prior to being discharged into the product collection vessel 180.

The pressure inside the tubular reactor can be controlled with a backpressure valve 170, which is generally positioned between the cooling device 160 and the sample collection vessel 180. The backpressure valve 170 controls the pressure at the exit of the reactor system 100 and helps to control the pressure within the tubular reactor 130. The backpressure is often at least 100 psi.

Any other known design of a continuous, tubular reactor can be used. For example, other suitable continuous, tubular reactors are described in an article by Adschiri et al., J. Am. Ceram. Soc., 75 (4), 1019-1022 (1992) and in U.S. Pat. No. 5,453,262 issued to Dawson et al. In these designs, the tube is straight and heated with electrical-resistance heaters surrounding the tubular reactor. Other types of heaters such as, for example, induction heaters, microwave heaters, fuel-fired heaters, and steam coils can be used.

The dimensions of the tubular reactor can be varied and, in conjunction with the flow rate of the feed composition, can be selected to provide suitable residence times for the reactants within the tubular reactor. Any suitable length tubular reactor can be used provided that the residence time is sufficient to convert the metal-carboxylate complex to metal oxide nanoparticles. The tubular reactor often has a length of at least 0.5 meter, at least 1 meter, at least 2 meters, at least 3 meters, at least 5 meters, at least 10 meters, at least 20 meters, at least 30 meters, at least 40 meters, or at least 50 meters. The length of the tubular reactor in some embodiments is less than 500 meters, less than 400 meters, less than 300 meters, less than 200 meters, less than 150 meters, less than 120 meters, less than 100 meters, less than 80 meters, or less than 60 meters.

Tubular reactors with a relatively small inner diameter are typically preferred. For example, tubular reactors having an inner diameter no greater than about 3 centimeters are often used because of the fast rate of heating of the feed composition that can be achieved with these reactors. Also, the temperature gradient across the tubular reactor is smaller for reactors with a smaller inner diameter compared to those with a larger inner diameter. The larger the inner diameter of the tubular reactor, the more this reactor undesirably resembles a batch reactor. However, it the inner diameter of the tubular reactor is too small, there is an increased likelihood of the reactor becoming plugged or partially plugged during operation resulting from deposition of material on the walls of the reactor. The inner diameter of the tubular reactor is often at least 0.1 centimeters, at least 0.15 centimeters, at least 0.2 centimeters, at least 0.3 centimeters, at least 0.4 centimeters, at least 0.5 centimeters, or at least 0.6 centimeters. In some embodiments, the diameter of the tubular reactor is no greater than 3 centimeters, no greater than 2.5 centimeters, no greater than 2 centimeters, no greater than 1.5 centimeters, or no greater than 1.0 centimeters. Some tubular reactors have an inner diameter in the range of 0.1 to 3.0 centimeters, in the range of 0.2 to 2.5 centimeters, in the range of 0.3 to 2 centimeters, in the range of 0.3 to 1.5 centimeters or in the range of 0.3 to 1 centimeters.

Rather than increasing the inner diameter of the tubular reactor, it may be preferable to use multiple tubular reactors having a smaller inner diameter arranged in a parallel manner. For example, rather than increasing the inner diameter of the tubular reactor to produce a larger amount of iron-containing metal oxides, multiple tubular reactors having an inner diameter no greater than about 3 centimeters can be operated in parallel.

Any suitable flow rate of the feed composition through the tubular reactor can be used as long as the residence time is sufficiently long to convert the precursor to metal oxide nanoparticles. Higher flow rates are desirable for increased throughput. The flow rate is often selected based on the residence time needed to decompose the precursor and to form the metal oxide nanoparticles. A higher flow rate can often be used when the length of the reactor is increased or when both the length and diameter of the reactor are increased. The flow through the reactor can be either laminar or turbulent.

The tubular reactor is held at a temperature that is greater than the decomposition temperature of the precursor. The first organic solvent is usually selected so that it has a boiling temperature that is greater than the decomposition temperature of the precursor. The reactor temperature can be selected to be above or below the boiling temperature of the first organic solvent. In some embodiments, it can be preferable to select a reactor temperature that is below the boiling temperature of the first organic solvent to minimize the pressure in the tubular reactor. In other embodiments, it can be preferable to select a reactor temperature that is above the boiling temperature of the first organic solvent (i.e., the reactor can be operated under solvothermal conditions).

It is typically desirable to select a reactor temperature that is lower than the decomposition reaction of the first organic solvent. Decomposition of the first organic solvent can result, at least in some embodiments, in an undesirably large pressure within the tubular reactor. Additionally, decomposition of the first organic solvent can result in reactions between the metal oxide nanoparticles and the decomposition products of the first organic solvent. For example, depending on the decomposition products of the first organic solvent, the metal oxide nanoparticles may undergo a reduction reaction.

The tubular reactor temperature is often at least 250° C. If lower temperatures are used, the precursor may not undergo decomposition or may undergo only partial decomposition. Exemplary reactor temperatures are often at least 260° C., at least 270° C., at least 275° C., at least 280° C., at least 290° C., or at least 300° C. The tubular reactor temperature is typically no greater than 400° C. If higher temperatures are used, the first organic solvent may undergo decomposition. Additionally, the formed particles may be too large (e.g., larger than 100 nanometers or 1000 nanometers) and are more likely to aggregate. Further, safety concerns become more problematic with higher temperatures. Exemplary reactor temperature are often no greater than 375° C., no greater than 350° C., no greater than 340° C., no greater than 330° C., no greater than 325° C., no greater than 320° C., no greater than 310° C., or no greater than 300° C. In some specific examples, the reactor temperature is in the range of 250° C. to 350° C., in the range of 250° C. to 325° C., in the range of 275° C. to 325° C., or at 300° C. Larger metal oxide nanoparticles can typically be produced by increasing the tubular reactor temperature.

The heating rate of the feed composition in the tubular reactor can affect the particle size distribution. In some embodiments, the heating rate is desirably at least 250° C. per minute, at least 300° C. per minute, at least 350° C. per minute, at least 400° C. per minute, at least 500° C. per minute, at least 600° C. per minute, at least 800° C. per minute, or at least 1000° C. per minute. The feed composition is typically held at a temperature up to 30° C., up to 40° C., up to 60° C., up to 80° C., up to 100° C., or up to 110° C. prior to entry into the portion of the tubular reactor that is positioned within a heating element or heating medium.

The heating rate in the tubular reactor can be calculated using the classical results for unsteady state heat transfer by conduction in an infinite cylinder. The fact that the heat transfer may be improved by forced and natural convection within the tubular reactor was not considered in the calculations, which are described further in the Example section and in the reference by Welty et al., Fundamentals of Momentum, Heat, and Mass Transfer, pages 290-293 and Appendix F, John Wiley and Sons, Inc., 1969.

Although not wanting to be bound by theory, a rapid heating rate within the tubular reactor may result in the nearly simultaneous decomposition of the precursor and nucleation/growth of the metal oxide nanoparticles. Much of the art related to the formation of metal oxides using decomposition reactions teaches the advantages of separating the decomposition reaction from the nucleation/growth reactions. In the art, the decompositions typically involve slow heating of the reactants or multiple stages of heating of the reactants at different temperatures. Variables such as the reactant concentrations, reactant ratios, and the boiling temperature of the solvent are used in the art to control particle size in thermal decomposition methods.

Unexpectedly, with the continuous, tubular reactors used herein, higher heating rates tend to result in a narrower particle size distribution of the resulting iron-containing metal oxide nanoparticles compared to lower heating rates. This is observed with different precursor concentrations and different precursor to surfactant ratios. At lower heating rates such as those below about 200° C. per minute, the particle size distribution can be correlated to the residence time in the tubular reactor. That is, the particle size distribution tends to broaden with increased residence times. Although not wanting to be bound by theory, the broadening of the particle size distribution may be the result of Oswald ripening. The small particles dissolve and then reform on larger particles (i.e., the dissolved material tends to add to larger particles). However, at higher heating rates, the particle size distribution usually does not broaden with increased residence times. That is, the effects of Oswald ripening are less. Once formed, there is little change in the size of the particles.

Tubular reactors having an inner diameter no greater than about 3 centimeters are particularly well suited for rapid heating of the feed composition. This heating rate of the feed composition in these tubular reactors can be considerably higher than the heating rate of the feed composition in a batch reactor such as a batch reactor having a volume greater than 1000 mL. Further, tubular reactors such as those described herein tend to provide a more uniform temperature profile across the reactor compared to a batch reactor such as those having a volume greater than 1000 mL. To prepare an amount of the metal oxide nanoparticles comparable to amounts prepared in a batch reactor, multiple parallel tubular reactors can be used.

The residence time in the heated portion of the tubular reactor is typically at least 1 minute, at least 2 minutes, at least 3 minutes, at least 5 minutes, or at least 10 minutes. If the residence time is too short, the decomposition reaction of the iron-carboxylate complex and the formation of iron-containing metal oxide nanoparticles may not be complete. The residence time is typically less than 60 minutes, less than 40 minutes, less than 30 minutes, or less than 20 minutes. The residence time can be varied by altering the dimensions of the tubular reactor and the flow rate through the tubular reactor.

The effluent from the tubular reactor includes the iron-containing metal oxide nanoparticles. The reactor effluent can be further processed. In some embodiments, the first organic solvent can be replaced with another organic solvent that is suitable for the end use of the metal oxide nanoparticles. In other embodiments, the first organic solvent is removed to concentrate or to isolate the iron-containing metal oxide nanoparticles. Any methods known for replacing the first organic solvent or for removing the first organic solvent can be used.

In some embodiments, the first organic solvent is removed or replaced from the reactor effluent using tangential flow filtration. With this filtration technique, the reactor effluent is pumped tangentially to the surface of a filter membrane. Any filter membrane suitable for use with nanoparticles can be used. For example, polysulfone hollow fiber filter modules that are commercially available from Spectrum Labs (Rancho Dominguez, Calif.) can be used. Applied pressure forces a portion of the reactor effluent through the filter membrane. Smaller molecular species such as the solvent and soluble impurities such as excess surfactant and soluble decomposition products may pass through the filter membrane while the metal oxide nanoparticles recirculate in a flow tangential to the filter membrane. The concentration of metal oxide nanoparticles in the fluid stream can be increased by the removal of the first organic solvents. The percent solids in the fluid stream can be increased to any amount that can be adequately pumped.

In many embodiments that include the use of tangential flow filtration, as the first organic solvent is removed from the fluid stream, a second organic solvent can be added to the fluid stream. The amount of second organic solvent added can be equal to or less than the amount of first organic solvent removed. The first organic solvent can be replaced with a second solvent that is easier to remove by a process such as evaporation, distillation, or drying compared to the first organic solvent. That is, a second organic solvent can be chosen that has a relatively low boiling point or relatively high vapor pressure compared to the first organic solvent. Alternatively, the second organic solvent can be chosen to be a solvent that is more compatible with a particular use of the metal oxide nanoparticles. The second organic solvent is often a nonpolar solvent because some polar solvents may not be compatible with various components of the tangential flow filtration equipment. Suitable second organic solvents include, for example, alkanes such as hexane and heptane.

In some other embodiments, the metal oxide nanoparticles can be isolated from the reactor effluent by the addition of another solvent that flocculates the metal oxide nanoparticles. This solvent is typically chosen to be one that does not disperse the metal oxide nanoparticles effectively and can be referred to as antisolvents. Solvents that can cause flocculation include, for example, acetone, and alcohols having 1 to 4 carbon atoms such as methanol, ethanol, and isopropanol. The flocculated metal oxide nanoparticles tend to precipitate and can be filtered or centrifuged from the second organic solvent, the flocculating solvent, or mixtures thereof. The filtered or centrifuged metal oxide nanoparticles can be dried to form a powder that is subsequently dispersed in another solvent. This other solvent can be polar or nonpolar and is often selected to be compatible with a particular use of the metal oxide nanoparticles such as, for example, a coating composition. Exemplary solvents for coating compositions include, but are not limited to, tetrahydrofuran, methyl ethyl ketone, methyl isobutyl ketone, hexanes, heptanes, methylene chloride, toluene, or mixtures thereof.

Another method of preparing iron-containing metal oxide nanoparticles is provided that includes preparing a feed composition that contains (a) a precursor that includes an iron-carboxylate complex, (b) a first surfactant comprising a first carboxylic acid, a salt of the first carboxylic acid, or a combination thereof, (c) a first organic solvent, and (d) iron-containing metal oxide seed particles. The method further includes passing the feed composition through a continuous, tubular reactor to form a reactor effluent containing the iron-containing metal oxide nanoparticles. The tubular reactor is held at a reactor temperature that is greater than the decomposition temperature of the iron-carboxylate complex. The resulting iron-containing metal oxide nanoparticles have an average particle size that is greater than an average particle size of the iron-containing metal oxide seed particles. The precursor, surfactant, and first organic solvent are the same as described above.

In this method, the iron-containing metal oxide seed particles can be prepared by any known process. In many embodiments, however, the iron-containing metal oxide seeds particles are produced by passing a first feed composition through a continuous, tubular reactor. The precursor in the first feed composition is converted to a first reactor effluent that contains iron-containing metal oxide nanoparticles that are used as the iron-containing metal oxide seed particles in a second feed composition. That is, the second feed composition includes the iron-containing seed particles combined with a precursor, surfactant, and first organic solvent. The iron-containing metal oxide nanoparticles used as seed particles in a second feed composition can be the reactor effluent from a first tubular reactor without any isolation of metal oxide nanoparticles from the other components of the reactor effluent. Alternatively, the iron-containing metal oxide nanoparticles used as seed particles can be isolated or separated from the byproducts produced in the first tubular reactor prior to being combined with the other components of the second feed composition.

The metal oxide nanoparticles prepared using any of the above described methods typically have an average particles size in the range of 1 to 100 nanometers. Because the nanoparticles are mainly spherical, the particle size corresponds to the particle diameter. Some exemplary metal oxide particles have an average size in the range of 1 to 75 nanometers, 1 to 50 nanometers, 1 to 40 nanometers, 1 to 30 nanometers, 1 to 20 nanometers, 3 to 50 nanometers, 3 to 30 nanometers, 3 to 20 nanometers, 5 to 50 nanometers, 5 to 30 nanometers, 5 to 20 nanometers, or 5 to 15 nanometers.

The metal oxide nanoparticles are typically crystalline. The crystalline nature of the metal oxide nanoparticles can be characterized using techniques such as x-ray diffraction or electron diffraction.

In some embodiments, the metal oxide nanoparticles can be magnetic. Particles less than about 25 to 30 nanometers are often superparamagnetic. If the particles are larger than about 25 to 30 nanometers, they are often paramagnetic.

The metal oxide nanoparticles produced in any of the methods described herein can be further reacted to produce nanoparticles having a different oxidation state than that formed within the tubular reactor. In some embodiments, the metal oxide nanoparticles can be oxidized. For example, metal oxide nanoparticles containing iron(II) such as magnetite (Fe₃O₄) can be oxidized to gamma-iron oxide or alpha-iron oxide. Any known method of oxidizing the metal oxide nanoparticles can be used. Exemplary oxidation reactions can be performed by heating powdered metal oxide nanoparticles in air or by treating a slurry of the nanoparticles with an oxidizing agent that is soluble in the slurry. In other embodiments, the metal oxide nanoparticles can be reduced. For example, metal oxide nanoparticles containing either iron(II) or iron(III) can be reduced to an iron-containing metal. Any known method of reducing the metal oxide nanoparticles can be used. Exemplary reduction reactions can be performed by heating powdered metal oxide nanoparticles in hydrogen or by treating a slurry of the nanoparticles with a reducing agent that is soluble in the slurry.

The methods described herein have a number of advantages over known methods of making metal oxides using decomposition reactions within a batch reactor. To prepare large quantities of the metal oxide nanoparticles using a batch process, a relatively large diameter reactor would most likely be chosen. Heat transfer through a large batch reactor can be problematic. The temperature gradient across such a reactor, even when stirred, tends to be significantly larger than the temperature gradient across the diameter of a flow-through tubular reactor such as a tubular reactor having an inner diameter no greater than about 3 centimeters. The uniformity of the reactor temperature affects the uniformity of precursor decomposition conditions and nanoparticles formation.

Further, conditions that are suitable in a small batch reactor can be difficult to scale-up to a batch reactor having a significantly different diameter. In contrast, because of the greater similarity in the temperature profiles between a small and large tubular reactor compared to the temperature profiles between a small and large batch reactor, the conditions needed in a larger tubular reactor are easier to predict from the conditions used in a smaller tubular reactor. Further, rather than increasing the diameter of the tubular reactor, multiple smaller diameter tubular reactors can be operated in parallel to increase the throughput. With the use of multiple parallel reactors, the reaction conditions would not need to be altered with an increase in the volume processed through the tubular reactor system.

Still further, the feed composition can typically be heated in a tubular reactor from room temperature to the reaction temperature in a fraction of the time required within a batch reactor. Less time to the reaction temperature can increase the overall throughput through the reactor system. As discussed above, faster heating rates in the tubular reactor can often lead to the production of metal oxide nanoparticles with an improved particle size distribution compared to batch reactors.

The metal oxide nanoparticles produced by the methods described herein can be used, for example, in numerous applications. Because the magnetic properties of the metal oxide nanoparticles are size dependent, the substantially non-aggregated particles prepared by the methods described herein can be particularly advantageous for applications requiring superparamagnetic materials. For example, superparamagnetic metal oxide nanoparticles can be used in various biological separation applications. The superparamagnetic nanoparticles can be attached using various chemistries to a biological material of interest. Magnetic forces can be used to concentrate the biological material or to separate the biological material of interest from other materials.

### EXAMPLES

These examples are merely for illustrative purposes and are not meant to limit the scope of the appended claims. All parts, percentages, ratios, etc. in the examples are by weight, unless noted otherwise.

Ethanol (95%), hexanes, acetone, isopropanol, and toluene were obtained from EMD (San Diego, Calif.). All other reagents were obtained from Sigma-Aldrich Chemical Company (Milwaukee, Wis.) unless otherwise noted.

### Test Methods

### Transmission Electron Microscopy (TEM)

Samples were prepared for TEM imaging by either placing a drop of the undiluted sample or by placing a drop of the diluted sample (1 part sample mixed with 2 parts hexane) onto a 400 mesh copper TEM grid with an ultra-thin carbon substrate on top of a mesh of lacey carbon (Ted Pella Inc., Redding, Calif.). Part of the drop was removed by touching the side or bottom of the grid with filter paper. The remainder was allowed to dry. This allowed the particles to rest on the ultra-thin carbon substrate and to be imaged with the least interference from a substrate.

TEM images were recorded at multiple locations across the grid. Enough images were recorded to allow sizing of a minimum of 500 to 1000 particles. Where applicable, the same grids were used to obtain selected area electron diffraction patterns.

TEM images were obtained using a Hitachi H-9000 high resolution transmission electron microscope operating at 300 KV (with a LaB₆ source). Images were recorded using a Gatan Ultrascan CCD camera (Model No. 895, 2 k×2 k chip). Images were taken at a magnification of 50,000× and 100,000×. For some samples, images were also taken at a magnification of 300,000×.

TEM analysis for selected area electron diffraction patterns was performed on a JEOL 200CX transmission electron microscope operating at 200 KV (with a LaB₆ source). Patterns were recorded on negative film (Kodak 4489) using a camera length of 100 cm and then scanned to convert the patterns to digital images using an Epson Perfection 4870 scanner.

### Crystalline Structure and Size (X-ray Diffraction Analysis)

Metal oxide (iron oxide) samples were examined as thin layers on zero background specimen holders composed of single crystal quartz. If needed, iron oxide samples that contained coarse particles were reduced by hand grinding using an agate mortar and pestle to produce a uniform thin layer.

X-ray diffraction scans for iron oxide samples were obtained using a Philips vertical diffractometer having a reflection data collection geometry (Panalytical, Natick, Mass., USA), copper K_{α} radiation, and proportional detector registry of the scattered radiation. The diffractometer was fitted with variable incident beam slits, fixed diffracted beam slits, and a graphite diffracted beam monochromator.

A survey scan was recorded from 10 to 100 degrees two-theta (20) using a 0.04 degree step size and 8 second dwell time. X-ray generator settings of 45 kV and 35 mA were used. The observed diffraction peaks were identified by comparison to the reference diffraction patterns contained within the International Centre for Diffraction Data (ICDD) powder diffraction database (Newton Square, Pa.) and attributed to the appropriate iron oxide phase. The amounts of each iron oxide phase were evaluated on a relative basis and the iron oxide phase having the most intense diffraction peak was assigned the intensity value of 100. The strongest line of the remaining crystalline iron oxide form was scaled relative to the most intense line and given a value between 1 and 100.

Peak widths for the observed diffraction maxima due to magnetite were measured by profile fitting. The following magnetite peak widths were evaluated: magnetite (ICDD PDF 0-19-629, cubic, F_{d-3m}): (220), (311) (400), (422), (511), and (440).

Sample peaks were corrected for instrumental broadening by interpolation of instrumental breadth values from corundum instrument calibration and corrected peak widths converted to units of radians. Corrected sample peak width (13) were used to evaluate primary crystal (crystallite) size by application of the Scherrer equation.

Crystallite Size (D)=Kλ/β (cosine θ)

where β refers to the calculated peak width after correction for instrumental broadening (in radians) and is equal to [calculated peak FWHM−instrumental breadth] (converted to radians); K is equal to a form factor (here 0.9); λ is equal to the wavelength (1.540598 Å); and θ is equal to half the peak position (scattering angle in degrees). FWHM refers to the full width of the diffraction peak at half the maximum height of the peak.

The arithmetic mean of the magnetite phase was calculated using the individual values for the magnetite (220), (311), (400), (422), (511) and (440) diffraction maxima. That is, the magnetite mean crystallite size is equal to

[D(220)+D(311)+D(400)+D(422)+D(511)+D(440)]/6.

For all profile fitting evaluations, a Pearson VII peak shape model with K_{α1} and K_{α2} wavelength was use as well as a linear background model. Widths were found as the peak full width at half maximum (FWHM) having units of degrees. The profile fitting was accomplished by use of the capabilities of the JADE (version 7.2, Materials Data Inc., Livermore, Calif.) diffraction software suite.

### Tubular Reactors

Three different tubular reactors were used for Examples 1-8. Details of the tubular reactors are shown in Table 1.

TABLE 1
Parameters for Tubular Reactors

| | | | | | | | | | Volume of | |
|---|---|---|---|---|---|---|---|---|---|---|
| | | | | | | | | | tubing | |
| | Outer | | wall | | Internal | | | | submerged | |
| Reactor | diameter | | thickness | | radius | | Length | | in oil | Heating rate |
| A | 0.125 | in | 0.028 | in | 0.035 | in | 100 | ft | 76 cm3 | 2688° C./min |
| | (0.318 | cm) | (0.071 | cm) | (0.089 | cm) | (3048 | cm) | | |
| B | 0.250 | in | 0.035 | in | 0.090 | in | 25 | ft | 125 cm3 | 367° C./min |
| | (0.635 | cm) | (0.089 | cm) | (0.229 | cm) | (762 | cm) | | |
| C | 0.375 | in | 0.035 | in | 0.153 | in | 10 | ft | 144 cm3 | 128° C./min |
| | (0.953 | cm) | (0.089 | cm) | (0.387 | cm) | (304.8 | cm) | | |

The effluent from Reactors A, B, and C was typically passed through a coil of an additional 20 feet of stainless steel tubing having an outside diameter of 0.125 inch (0.3175 cm) and a wall thickness of 0.028 inch (0.0711 cm) that was immersed in water bath for cooling purposes. A backpressure regulator valve was used to maintain an exit pressure of at least 100 psig.

### Determination of Heating Rate

For the tubular reactor, the heating rate is inversely proportional to the square of the radius of the column of liquid being heated. The heating rate for Examples 1 to 10 was calculated as described in chapter 18 (pages 290-293) of the reference, Welty et al., Fundamentals of Momentum, Heat, and Mass Transfer, John Wiley and Sons, Inc., 1969. The thermal conductivity was estimated from oleic acid (0.00055 cal/[sec-cm²-(C/cm)]). The feed composition density was measured as 0.8 g/cm³. The heat capacity was estimated as 0.5 cal/[g-C]. For the batch reactor used for Comparative Example 1, the solution temperature was monitored directly by a thermocouple and the time for the solution temperature to reach the designated temperature was recorded.

To use the Temperature-Time Charts for Simple Geometric Shapes (found in Appendix F of the above reference), one has to specify three dimensionless parameters which allows the user to determine the fourth dimensionless parameter from the chart. The first parameter is the unaccomplished temperature change, which in this example is (300−299)/(300−20)=0.0036. The second parameter is the relative position (ranges from 0 to 1) which for the center of the tube is 0. The third parameter is the relative resistance to heat transfer, which is a ratio of the conductive heat transfer to the convective heat transfer in the system. In this case the convective heat transfer is much greater than the conductive heat transfer, so the relative resistance is also 0. The fourth parameter is the relative time, which is equal to the thermal diffusivity multiplied by the time divided by the radius of the cylinder squared. From the charts mentioned above, this value is determined to be 1.1. The thermal diffusivity of the octadecene calculated from the physical properties given above (thermal diffusivity=thermal conductivity/density/heat capacity=0.00055/0.8/0.5) is 0.001375 cm²/sec. Therefore, the time for the center of a cylinder of radius r to reach the final temperature is t=800×r² sec where r is measured in cm. The average heating rate would then be calculated as (300−20)/(t/60)° C. per minute. If the radius of the tube was 1 millimeter (0.1 cm), then the time, t, would be calculated to be 8 seconds and the average heating rate would be (=16800/8) 2100° C. per minute.

### Particle Isolation Method 1

A tangential flow filtration (TFF) apparatus was assembled as described in KrosFlo® Research II TFF System: Product Information and Operating Instructions (Spectrum Labs, Rancho Dominguez, Calif.). MASTERFLEX L/S 16 VITON tubing (Cole Parmer, Vernon Hills, Ill., P/N 06412-16) was used. This filtration method recirculates a solution through a hollow fiber filter module. An applied trans-membrane pressure forces a portion of the solution through the filter module tangential to the recirculation flow direction. The recirculated solution is referred to as retentate and the solution passing through the membrane wall is referred to as permeate. Filter modules of varying molecular weight cutoffs may be used to achieve separation of solution components based on size. The apparatus may be operated in diafiltration mode (permeate is replaced with fresh solvent, keeping the retentate at a constant volume). The apparatus may also be operated in concentrate mode (permeate is not replaced, reduced volume therefore increases the concentration of the retentate).

To prepare the dry module, isopropanol was recirculated through the module at 445 mL/min until 300 mL of permeate was obtained. Then isopropanol was replaced with heptane, which was recirculated at 445 mL/min until at least 700 mL of permeate was obtained.

The effluent (i.e., product sol) from the tubular reactor was diluted 1:1 vol/vol with hexanes or heptane and processed through the TFF apparatus, using a hollow fiber filter module (Spectrum Labs, Rancho Dominguez, Calif., P/N X21S-300-02N, 145 cm² filter area, 10 kilodalton cutoff). The flow rate had been set to give a shear value of 13449 sec-1. The dispersion was washed with 1 volume equivalent of hexanes or heptane, using the TFF in diafiltration mode with heptane as the replacement solvent. The dispersion was then concentrated to one-fourth to one-half the volume of the reactor effluent. The dispersion was washed with 4 volume equivalents of heptane, using the TFF in diafiltration mode. To isolate particles from the dispersion, an aliquot was removed and solvent allowed was evaporated under vacuum.

### Particle Isolation Method 2

To precipitate the particles, a flocculating solvent (acetone or ethanol) was added to the product dispersion. The volume ratio of the flocculating solvent to reactor effluent was 2.5 to 1. The sample was centrifuged to settle the particles, the supernatant was discarded and the residue dispersed in hexanes. The steps of addition of the flocculating solvent and the centrifugation were repeated. The material was then dispersed in another solvent to the desired concentration.

### Preparatory Example 1

### Fe-Oleate Precursor Preparation

A 3 L, three neck round-bottom flask was equipped with a stir bar, a condenser, and a thermocouple connected to an I²R THERMOWATCH. A solvent mixture was prepared by mixing 300 mL distilled H₂O and 400 mL ethanol (EtOH) together until homogeneous. Then 54.08 grams FeCl₃.6H₂O was added to the solvent mixture and stirred to form an orange, clear solution. Four aliquots (about 45 g each) of sodium oleate (182.67 grams total) were added at 2 minute intervals. The solid reacted immediately to form a dark red material. Then, 700 mL hexanes were added slowly. The reaction mixture was heated at 54° C. for 4 hours. The dark red organic layer was separated from the colorless aqueous layer. The organic layer was washed with water (2×225 mL). Using a high vacuum at ambient temperature, the organic layer was concentrated to a deep red oil. Yield: 182 grams.

### Comparative Example 1

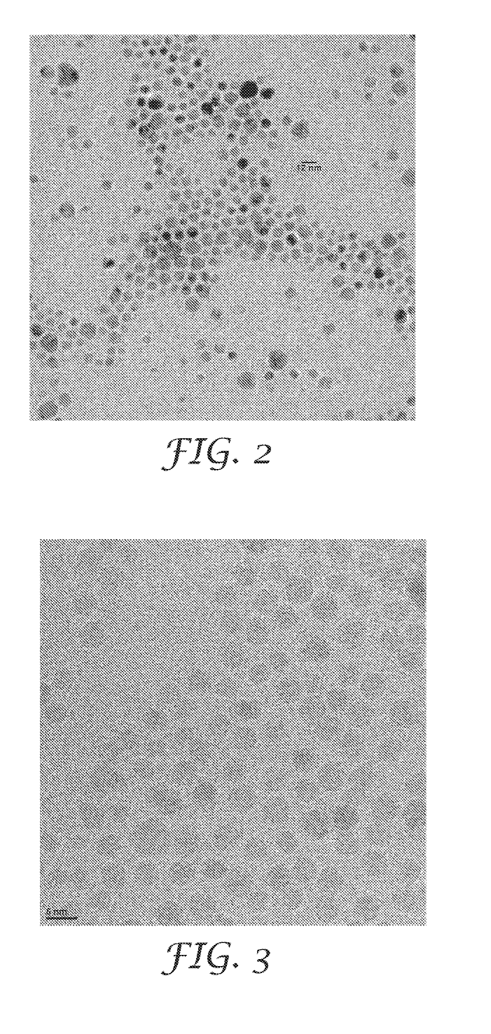

A round-bottom flask was loaded with Fe-oleate precursor (15.36 grams) from Preparatory Example 1. Octadecene, 90% (Alfa Aesar, Ward Hill, Mass.) (85 grams) and then oleic acid (MP Biomedicals, Inc., Solon, Ohio) (2.41 g) were added to the precursor. The reaction flask was equipped with a condenser and a thermocouple connected to an I²R THERMOWATCH. The solution was heated to 320° C. at 3° C./min. The solution was held at 320° C. for 30 minutes. The product was a black sol. The particles were isolated using isolation method 2. Particles were dispersed in hexanes to form a 1 mg/mL sol and evaluated using TEM. A representative TEM image is shown in FIG. 2. The magnification was 50,000×.

### Example 1

A feed composition was prepared by adding the Fe-oleate precursor (161.2 grams), which was prepared as described in Preparatory Example 1, to a plastic vessel. Octadecene (750 mL) and then oleic acid (25.3 grams) were added.

The feed composition was pumped at a rate of 2 mL/min through Tubular Reactor A as described in Table 1. The tubular reactor was immersed in a bath of DURATHERM S oil heated at 300° C. The residence time (i.e., the time the reaction stream was in the part of the tube that was immersed in the oil) was 38 minutes. The reactor conditions are summarized in Table 2. The product was a black sol.

The particles in the reactor product were washed according to Isolation Method 1. Two drops of the resulting dispersion were diluted in 2 mL hexanes. This sample was evaluated using TEM and XRD. A representative TEM image is shown in FIG. 3. The magnification was 300,000×. The characterization results are summarized in Table 3.

### Example 2

A feed composition was prepared by adding the Fe-oleate precursor (92.4 grams), which was prepared as described in Preparatory Example 1, to a plastic vessel. Octadecene (412 grams) and then oleic acid (14.2 grams) were added.

The feed composition was pumped at a rate of 2 mL/min through Tubular Reactor A as described in Table 1. The tubular reactor was immersed in a bath of DURATHERM S oil heated at 300° C. The residence time was 38 minutes. The reactor conditions are summarized in Table 2. The product was a black sol.

Drops of the reactor effluent were diluted in hexanes at concentration of 1-10 drops/mL. This sample was evaluated using TEM. The characterization results are summarized in Table 3.

### Example 3

A feed composition was prepared by adding the Fe-oleate precursor (92.4 grams), which was prepared as described in Preparatory Example 1, to a plastic vessel. Octadecene (412 grams) and then oleic acid (14.2 grams) were added.

The feed composition was pumped at a rate of 4 mL/min through Tubular Reactor A as described in Table 1. The tubular reactor was immersed in a bath of DURATHERM S oil heated at 300° C. The residence time was 19 minutes. The reactor conditions are summarized in Table 2. The product was a black sol.

Drops of the reactor effluent were diluted in hexanes at concentration of 1-10 drops/mL. This sample was evaluated using TEM. The characterization results are summarized in Table 3.

### Example 4

A feed composition was prepared by adding the Fe-oleate precursor (93.01 grams), which was prepared as described in Preparatory Example 1, to a plastic vessel. Octadecene (415 grams) and then oleic acid (16.0 grams) were added.

The feed composition was pumped at a rate of 4 mL/min through Tubular Reactor A as described in Table 1. The tubular reactor was immersed in a bath of DURATHERM S oil heated at 300° C. The residence time was 19 minutes. The reactor conditions are summarized in Table 2. The product was a black sol.

The particles in the reactor effluent were washed according to Isolation Method 1. Two drops of the resulting dispersion were diluted in 2 mL hexanes. This sample was evaluated using TEM. The characterization results are summarized in Table 3.

### Example 5

A feed composition was prepared by adding the Fe-oleate precursor (90.12 grams), which was prepared as described in Preparatory Example 1, to a plastic vessel. Octadecene (790 grams) and then oleic acid (34.5 grams) were added.

The feed composition was pumped at a rate of 4 mL/min through Tubular Reactor A as described in Table 1. The tubular reactor was immersed in a bath of DURATHERM S oil heated at 300° C. The residence time was 19 minutes. The reactor conditions are summarized in Table 2. The product was a black sol.

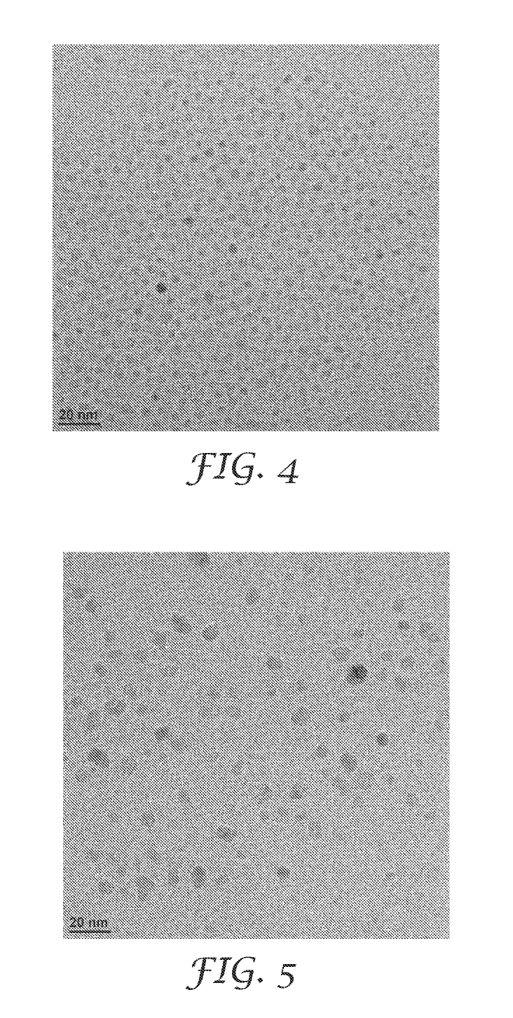

Drops of the reactor effluent was diluted in hexanes at concentration of 1-10 drops/mL. This sample was evaluated using TEM. A representative TEM image is shown in FIG. 4. The magnification was 100,000×. Isolation Method 2 was used to provide isolate particles for XRD analysis. The characterization results are summarized in Table 3.

### Example 6

To form the feed composition, 400 mL of the feed composition for Example 5 was mixed with 200 mL of the reactor effluent from Example 5.

The feed composition was pumped at a rate of 4 mL/min through Tubular Reactor A as described in Table 1. The tubular reactor was immersed in a bath of DURATHERM S oil heated at 280° C. The residence time was 19 minutes. The reactor conditions are summarized in Table 2. The product was a black sol.

Drops of the reactor product dispersion were diluted in hexanes at concentration of 1-10 drops/mL. This sample was evaluated using TEM. Isolation Method 2 was used to provide particles for XRD analysis. The characterization results are summarized in Table 3.

### Example 7

A feed composition was prepared by adding the Fe-oleate precursor (90.08 grams), which was prepared as described in Preparatory Example 1, to a plastic vessel. Octadecene (789 grams) and then oleic acid (34.52 grams) were added.

The feed composition was pumped at a rate of 16 mL/min through Tubular Reactor B as described in Table 1. The tubular reactor was immersed in a bath of DURATHERM S oil heated at 300° C. The residence time was 7.8 minutes. The reactor conditions are summarized in Table 2. The reactor product was a black sol.

Drops of the reactor product dispersion were diluted in hexanes at concentration of 1-10 drops/mL. This sample was evaluated using TEM. Isolation Method 2 was used to provide particles for XRD analysis. The characterization results are summarized in Table 3.

### Example 8

Example 8 is similar to Example 7 except that feed composition was pumped at a rate of 8 mL/min through Tubular Reactor B as described in Table 1. The residence time was 16 minutes. The reactor conditions are summarized in Table 2. The product was a black sol.

Drops of the reactor product dispersion were diluted in hexanes at concentration of 1-10 drops/mL. This sample was evaluated using TEM. A representative TEM image is shown in FIG. 5. The magnification was 100,000×. Isolation Method 2 was used to provide particles for XRD analysis. The characterization results are summarized in Table 3.

### Example 9

The feed composition was prepared as described in Example 1. The feed composition was pumped at a rate of 15 mL/min through Tubular Reactor C as described in Table 1. The tubular reactor was immersed in a bath of DURATHERM S oil heated at 300° C. The residence time was 9.6 minutes. The reactor conditions are summarized in Table 2. The product was a black sol.

Drops of the reactor product dispersion were diluted in hexanes at concentration of 1-10 drops/mL. This sample was evaluated using TEM. Isolation Method 2 was used to provide particles for XRD analysis. The characterization results are summarized in Table 3.

### Example 10

The feed composition was prepared as described in Example 1. The feed composition was pumped at a rate of 9.4 mL/min through Tubular Reactor C as described in Table 1. The tubular reactor was immersed in a bath of DURATHERM S oil heated at 300° C. The residence time was 15.3 minutes. The reactor conditions are summarized in Table 2. The product was a black sol.

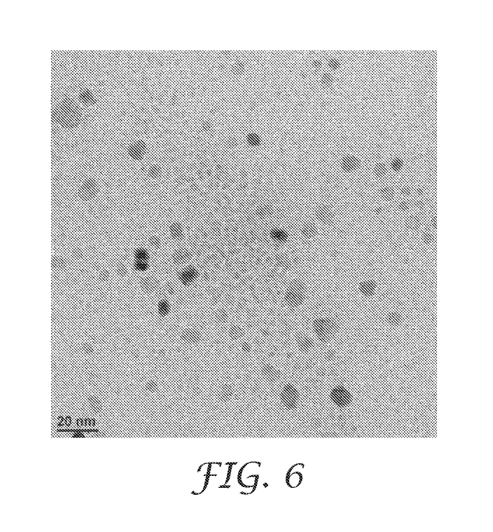

Drops of the reactor product dispersion were diluted in hexanes at concentration of 1-10 drops/mL. This sample was evaluated using TEM. A representative TEM image is shown in FIG. 6. The magnification was 100,000×. Isolation Method 2 was used to provide particles for XRD analysis. The characterization results are summarized in Table 3.

TABLE 2
Summary of reaction conditions

| | | | Mol ratio | Time from | | Total |
|---|---|---|---|---|---|---|
| Ex- | | Fe conc. | Oleic | 20° C. to | Flow rate | min |
| ample | Tube | Measured | acid:Fe | 300° C. | (mL/min) | 300° C. |
| C1 | N/A | 0.135M | 0.497 | 6000 sec | Batch- | 30 |
| | | calc | | | rbf | |
| 1 | A | 0.188M | 0.501 | 6.25 sec | 2 | 38 |
| | | calc | | | | |
| 2 | A | 0.146M | 0.485 | 6.25 sec | 2 | 38 |
| 3 | A | 0.146M | 0.485 | 6.25 sec | 4 | 19 |
| 4 | A | 0.152M | 0.549 | 6.25 sec | 4 | 19 |
| 5 | A | 0.080M | 1.22 | 6.25 sec | 4 | 19 |
| 6 | A | 0.074M | 1.22 | 6.25 sec | 4 | 19 |
| 7 | B | 0.077M | 1.22 | 45.6 sec | 16 | 8 |
| 8 | B | 0.077M | 1.22 | 45.6 sec | 8 | 16 |
| 9 | C | 0.080M | 1.22 | 130.4 sec | 15 | 10 |
| 10 | C | 0.080M | 1.22 | 130.4 sec | 9 | 16 |

TABLE 3
Characterization of Examples

| | | | TEM Particle size |
|---|---|---|---|
| | Crystallite | | (mean size, overall |
| Example | Size (Å) | Phase | distribution) |
| C1 | | | 9 nm, broad |
| 1 | 46 (3) | Magnetite | 4 nm, narrow *TFF |
| 2 | | | 4 nm, narrow |
| 3 | | | 4 nm, narrow |
| 4 | | | 4 nm, narrow *TFF |
| 5 | 47 (2) | Magnetite | 4 nm, narrow |
| 6 | 58 (5) | Magnetite | 6 nm, narrow |
| | 1199 (97) | | |
| 7 | 42 (4) | Magnetite | 5 nm, narrow |
| 8 | 77 (4) | Magnetite | 7 nm, broad |
| 9 | 65 (3) | Magnetite | 6 nm, broad |
| 10 | 94 (4) | Magnetite | 7 nm, broad, bimodal |

We claim:

1. A method of preparing iron-containing metal oxide nanoparticles, the method comprising:
preparing a feed composition comprising
a) a precursor comprising an iron-carboxylate complex;
b) a surfactant comprising a first carboxylic acid, a salt of the first carboxylic acid, or a mixture thereof; and
c) a first organic solvent; and
passing the feed composition through a continuous, tubular reactor held at a reactor temperature that is greater than the decomposition temperature of the iron-carboxylate to form a reactor effluent comprising the iron-containing metal oxide nanoparticles.

2. The method of claim 1, wherein the precursor further comprises a metal-carboxylate complex, a metal species in the metal-carboxylate complex being selected from a transition metal other than iron, rare earth element, or alkaline earth element.

3. The method of claim 1, wherein a heating rate of the feed composition in the tubular reactor is at least 250° C. per minute.

4. The method of claim 1, wherein the tubular reactor temperature is less than a boiling temperature of the first organic solvent.

5. The method of claim 1, wherein the tubular reactor temperature is equal to or greater than a boiling temperature of the first organic solvent.

6. The method of claim 1, wherein the iron-containing metal oxide nanoparticles comprise Fe₂O₃, M¹Fe₂O₄, M²FeO₃, M¹M²FeOₓ, or a combination thereof, where
M¹ is selected from iron, cobalt, nickel, copper, zinc, chromium, manganese, titanium, vanadium, barium, magnesium, calcium, strontium, or a combination thereof;
M² is a rare earth element; and
x is a number no greater than 4.

7. The method of claim 1, wherein the iron-containing metal oxide comprises Fe₃O₄.

8. The method of claim 1, wherein the iron-carboxylate complex comprises an iron-oleate complex and the surfactant comprises oleic acid, a salt of oleic acid, or a combination thereof.

9. The method of claim 1, wherein passing the feed composition through the tubular reactor comprises using a laminar flow rate.

10. The method of claim 1, further comprising subjecting the tubular reactor product to a tangential flow filtration method.

11. The method of claim 10, wherein the first organic solvent in the reactor product is exchanged with a second organic solvent having a lower boiling temperature.

12. A method of preparing iron-containing metal oxide nanoparticles, the method comprising:
preparing a feed composition comprising
a) a precursor comprising an iron-carboxylate complex, wherein the iron-carboxylate complex is formed by a method comprising
preparing an iron-containing salt solution comprising
i) an iron-containing salt; and
ii) an aqueous-based solvent;
mixing a complexing agent with the iron-containing salt solution, the complexing agent comprising a second carboxylic acid, a salt of the second carboxylic acid, or a mixture thereof; and
extracting the iron-carboxylate complex into a nonpolar organic solvent;
b) a surfactant comprising a first carboxylic acid, a salt of the first carboxylic acid, or a mixture thereof; and
c) a first organic solvent; and
passing the feed composition through a continuous, tubular reactor held at a reactor temperature that is greater than the decomposition temperature of the iron-carboxylate to form a reactor effluent comprising the iron-containing metal oxide nanoparticles.

13. The method of claim 12, wherein the precursor further comprises a metal-carboxylate complex, a metal species in the metal-carboxylate complex being selected from a transition metal other than iron, rare earth element, or alkaline earth element.

14. The method of claim 12, wherein a heating rate of the feed composition in the tubular reactor is at least 250° C. per minute.

15. The method of claim 12, further comprising subjecting the tubular reactor product to a tangential flow filtration method.

16. The method of claim 12, wherein the first organic solvent in the reactor product is exchanged with a second organic solvent having a lower boiling temperature.

17. A method of preparing iron-containing metal oxide nanoparticles, the method comprising:
preparing a feed composition comprising
a) a precursor comprising an iron-carboxylate complex;
b) a surfactant comprising a first carboxylic acid, a salt of the first carboxylic acid, or a mixture thereof;
c) a first organic solvent; and
d) iron-containing metal oxide seed particles; and
passing the feed composition through a continuous, tubular reactor held at a reactor temperature that is greater than the decomposition temperature of the iron-carboxylate to form a reactor effluent comprising the iron-containing metal oxide nanoparticles, wherein the iron-containing metal oxide nanoparticles have an average particles size that is greater than an average particle size of the iron-containing metal oxide seed particles.

18. The method of claim 17, wherein a heating rate of the feed composition in the tubular reactor is at least 250° C. per minute.

19. The method of claim 17, further comprising subjecting the tubular reactor product to a tangential flow filtration method.

20. The method of claim 17, wherein the iron-containing metal oxide seed particles are formed by a process comprising passing a first feed solution comprising a first iron-carboxylate complex through a continuous, tubular reactor to decompose the first iron-carboxylate complex to form the iron-containing metal oxide seed particles.
